(19) United States
(12) Patent Application Publication
(10) Pub. No.: US 2001/0032319 A1
(43) Pub. Date: Oct. 18, 2001

(54) Biometric security system for computers and related method

(75) Inventor: Dale R. Setlak, Melbourne, FL (US)

Correspondence Address: CHRISTOPHER F. REGAN, Allen, Dyer, Doppelt, Milbrath & Gilchrist, P.A., P.O. Box 3791, Orlando, FL, 32802-3791, US

(73) Assignee: Authentec, Inc., Melbourne, FL (US)

(21) Appl. No.: 09/757,293

(22) Filed: Jan. 9, 2001

Related U.S. Application Data
(60) Provisional application No. 60/175,362, filed on Jan. 10, 2000.
(60) Provisional application No. 60/177,803, filed on Jan. 25, 2000.

(51) Int. Cl. H04L 9/00; H04K 1/00

(52) U.S. Cl. 713/201; 713/186

(57) ABSTRACT

A computer includes at least one memory, basic input/output system (BIOS) instructions and operating system (OS) instructions stored in the at least one memory, and a processor connected to the at least one memory and which upon starting first operates based upon the BIOS instructions and thereafter operates based upon the OS instructions. A timer is provided for shutting down the processor a predetermined time after being started unless a deactivation code is received. A biometric security sensor cooperates with the processor for causing the deactivation code to be received by the timer based upon at least one sensed user biometric indicating an authorized user. The BIOS instructions may cause the processor to calculate the deactivation code and start the timer.

### RELATED APPLICATIONS

The present application is based upon copending provisional application Ser. No. 60/175,362 filed Jan. 10, 2000, and is also based upon copending provisional application Ser. No. 60/177,803 filed Jan. 25, 2000 which are hereby incorporated herein in their entirety by reference.

### FIELD OF THE INVENTION

The present invention relates to the field of computers, and, more particularly, to a biometric protection system and related method for reducing unauthorized access to computers.

### BACKGROUND OF THE INVENTION

The use of passwords as a security measure for preventing unauthorized users from gaining access to a computer is widely known. For example, a computer's operating system (OS) software may cause the computer's processor to prompt the user for authentication indicia before completing the OS startup procedure. The authentication indicia may include an alphanumeric password or biometric data, such as data generated by a fingerprint sensor, for example. The authentication indicia may also be required after a computer is left idle for a period of time.

One problem with such OS resident authentication systems is that they may be easily bypassed by unauthorized users or “hackers.” As a result, these systems do not provide an effective deterrent against would-be computer thieves. That is, the thieves know that they can gain access to the computer's hardware and disable the OS authentication system so that the computer may be sold and used by others. Naturally, the problem of computer theft is particularly acute for portable laptop computers which are much easier for thieves to conceal and transport.

One recent approach to discouraging theft of computers includes incorporating an authentication system into the computer that prevents the computer's hardware from functioning independent from its operating system. These approaches typically focus on using the computer's basic input/output system (BIOS) instructions to cause the computer's processor to execute the authentication system prior to startup of the operating system.

One example of such a BIOS resident authentication system is found in U.S. Pat. No. 5,892,906 to Chou et al. entitled “Apparatus and Method for Preventing Theft of Computer Devices.” In this system, a password or other unique information is supplied to the computer before the computer BIOS routines can be completely executed. The BIOS instructions include a security routine for determining whether or not the required password entered by the user is present.

Another example is found in U.S. Pat. No. 5,960,084 to Angelo entitled “Secure Method for Enabling/Disabling Power to a Computer System Following Two-Piece User Verification.” According to this patent, power is supplied only to limited components of a computer upon startup so that the authentication procedure may be run. During the authentication procedure, the computer user is required to provide an external token or smart card that is coupled to the computer through specialized hardware. The token or smart card is used to store an encryption algorithm furnished with an encryption key that is unique or of limited production. The computer user is also required to enter a password. Once entered, the password is encrypted using the encryption algorithm to create a system password. The system password is compared to a value stored in a secure memory. If the two values do not match, power to the entire computer system is disabled.

Although such BIOS resident authentication systems can be effective, they do have certain drawbacks. For example, if the user is required to enter an OS or network password, the user will then have to login twice each time the computer is booted up. That is, the user will have to login once for the BIOS identification system and once for the OS or network.

Furthermore, when a user authentication system is installed in the BIOS, it is the only authentication system that can be used for a hardware startup without changing the BIOS. Thus, if the instructions stored in the BIOS require a single biometric security sensor, for example, the user may not be able to upgrade to sensors including new technology or to use multiple biometric sensors. Similarly, BIOS resident authentication systems generally must be installed at the factory and cannot be easily changed or upgraded by the user.

Another drawback of BIOS resident authentication systems is that they may have very limited functionality. This is because the BIOS software must be small enough to fit into the limited storage space available in a BIOS memory, which is typically a read only memory (ROM) chip. As a result, only limited biometrics and graphical user interfaces (GUIs) may be used, as opposed to OS resident authentication systems that enjoy a vast amount of storage space because they are generally stored on a magnetic disk.

### SUMMARY OF THE INVENTION

In view of the foregoing background, it is therefore an object of the present invention to provide a biometric security system and related method that prevents a computer's hardware from functioning independent from its operating system while still retaining the benefits associated with OS resident authentication systems.

This and other objects, features, and advantages in accordance with the present invention are provided by a computer including at least one memory, basic input/output system (BIOS) instructions and operating system (OS) instructions stored in the at least one memory. The computer may also include a processor connected to the at least one memory and which upon starting first operates based upon the BIOS instructions and thereafter operates based upon the OS instructions. A timer may be provided for shutting down the processor a predetermined time after being started unless a deactivation code is received. A biometric security sensor may cooperate with the processor for causing the deactivation code to be received by the timer based upon at least one sensed user biometric indicating an authorized user. The BIOS instructions may cause the processor to calculate the deactivation code and start the timer.

More specifically, the computer may include an enabling device which, until activation, prevents the timer from shutting down the processor. The enabling device may include at least one of a write-once memory, a jumper, and a fusible link. Also, the OS instructions may cause the processor to activate the enabling circuit responsive to a command from a user.

Additionally, the BIOS instructions may cause the processor to calculate the deactivation code and start the timer prior to the processor operating based upon the OS instructions. Moreover, the OS instructions may cause the processor to cooperate with the biometric security sensor for causing the deactivation code to be received by the timer. The BIOS instructions may cause the processor to check and verify that the biometric security sensor and/or the timer is installed and operational. Further, the biometric security sensor may be a fingerprint sensor. The at least one memory may include a ROM memory for storing the BIOS instructions and a magnetic disk for storing the OS instructions.

A biometric security system according to the invention for a computer is also provided. The computer may include at least one memory having BIOS instructions and OS instructions stored therein and a processor connected to the at least one memory which upon starting first operates based upon the BIOS instructions and thereafter operates based upon the OS instructions. The biometric security system may include a timer for shutting down the processor a predetermined time after being started unless a deactivation code is received. The system may also include a biometric security sensor cooperating with the processor for causing the deactivation code to be received by the timer based upon at least one sensed user biometric indicating an authorized user. The BIOS instructions may cause the processor to calculate the deactivation code and start the timer.

A method aspect of the invention is for reducing unauthorized access to a computer including a processor. The method may include calculating a deactivation code and starting a timer responsive to basic input/output system (BIOS) instructions, causing the deactivation code to be received by the timer based upon at least one sensed user biometric indicating an authorized user, and shutting down the processor a predetermined time after being started unless the deactivation code is received by the timer.

### BRIEF DESCRIPTION OF THE DRAWINGS

FIG. 1 is a perspective view of a computer including a biometric protection system according to the present invention.

FIG. 2 is a schematic block diagram of the computer as shown in FIG. 1

FIG. 3 is a more detailed schematic block diagram of the processor and biometric security system of FIG. 2.

FIG. 4 is a flow chart illustrating a method for reducing unauthorized access to a computer using the biometric security system of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Referring now to FIG. 1, a computer 10 according to one aspect of the invention is first described. The computer 10 is shown to be a laptop computer, but the present invention is applicable to other computers as well, such as desktop computers and the like. The computer 10 includes a display 11 connected to a base 12. A keyboard 13 and a biometric security sensor 14 may be included on a top side of the base 12, for example. Of course, the biometric security sensor 13 may be mounted at other suitable locations on the computer 10. The biometric security sensor 13 may be a fingerprint sensor such as the FingerLoc® sensor manufactured by the assignee of the present invention, for example, although other devices may be used as well.

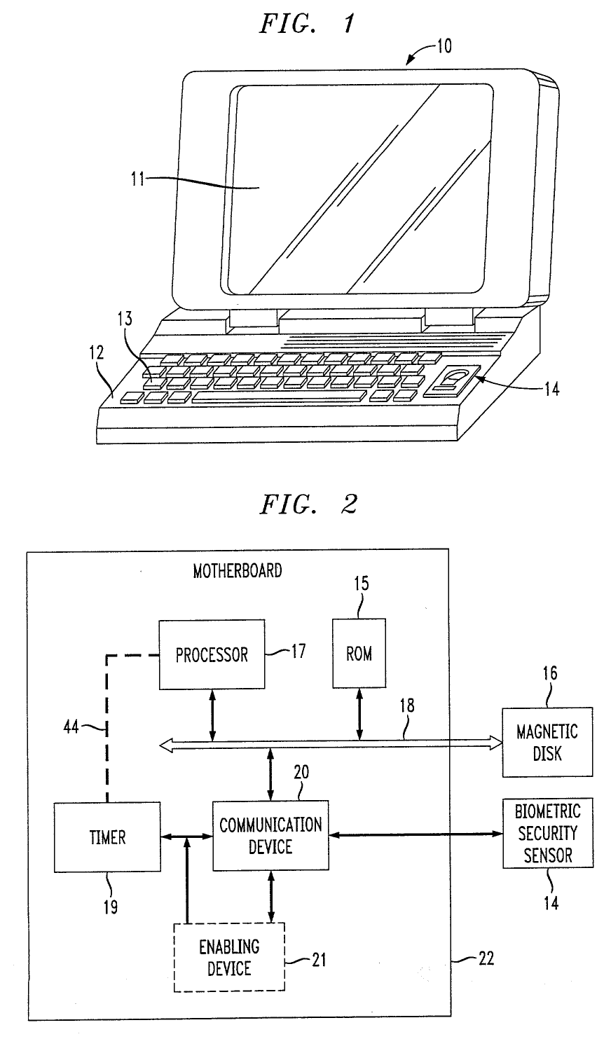

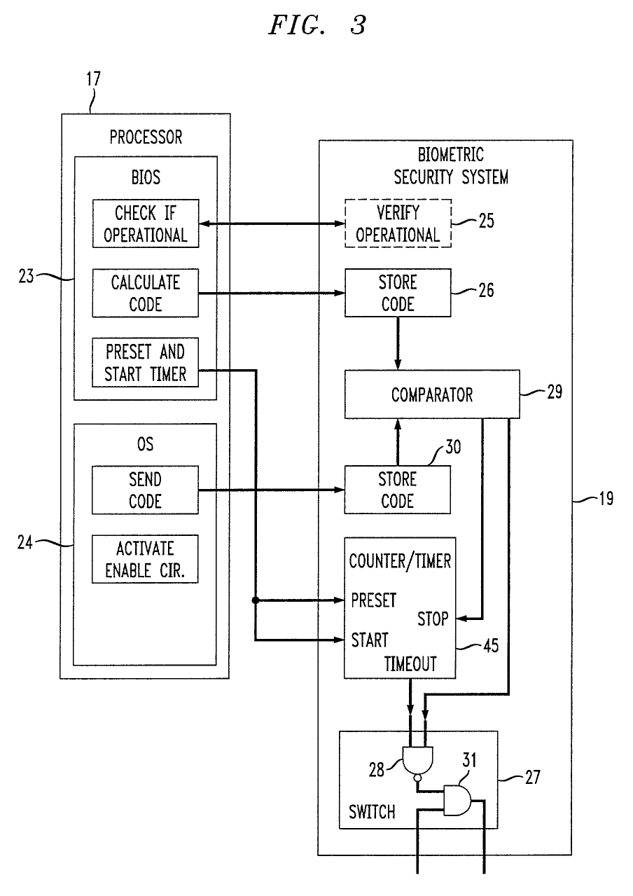

Referring now additionally to FIGS. 2 and 3, the computer 10 illustratively includes a motherboard 22 including a read only memory (ROM) 15 having basic input/output system (BIOS) instructions 23 stored therein. Other suitable memories for storing BIOS instructions known to these of skill in the art may also be used. A magnetic disk 16, (e.g., a hard disk) has operating system (OS) instructions 24 stored therein (see FIG. 3). The operating system may be Windows®, for example, although the present invention may be used with other operating systems as well. Special considerations for using the present invention with certain operating systems will be discussed in further detail below.

The motherboard 22 further carries a processor 17 connected to the ROM 15 and magnetic disk 16 via a bus 18, such as a universal serial bus (USB) or ISA bus, for example. The processor may be any suitable computer microprocessor, such as an Intel Pentium® processor, for example. Upon starting, the processor 17 first operates based upon the BIOS instructions 23 and thereafter operates based upon the OS instructions 24.

Furthermore, a timer 19 is also included for shutting down the processor 17 a predetermined time after being started unless a deactivation code is received. The timer 19 is coupled to the processor 17 via a communication device 20 connected to the bus 18 and via an optional connection 44. The optional connection 44 (shown with dotted lines) is for shutting down the processor if the deactivation code is received. The communication device 20 may be a transceiver, for example, though other suitable devices may also be used. The BIOS instructions 23 cause the processor 17 to calculate the deactivation code and start the timer 19. The biometric security sensor 14 cooperates with the processor 17 for causing the deactivation code to be received by the timer 19 based upon at least one sensed user biometric indicating an authorized user, as will be described further below.

As shown in FIG. 2, the timer 19, communication device 20, and enabling device 21 are all located on the motherboard 22. Of course, those of skill in the art will appreciate that these components need not be physically on the motherboard 22 and may be on a separate circuit card that plugs into the motherboard and connects to the bus 18, for example.

The computer 10 may optionally include an enabling device 21 which until activation prevents the timer from shutting down the processor 17. The enabling device 21 may be used to provide access to the computer 10 for initial integration and testing. For example, the enabling device 21 may be an integrated write-once memory. When the computer 10 is initially constructed, the write-once memory would be left in an off state to prevent the timer 19 from shutting down the processor 17. The biometric security system is turned on by writing to the write-once memory. Once enabled, the biometric security system may not be disabled without physically altering components in the computer 10.

Another embodiment of the enabling device 21 is a fusible link. For example, if the fusible link is intact, the biometric security system is disabled. By fusing the link, the biometric security system again cannot be disabled without physical alteration of the computer's hardware. Using an enabling device 21, such as those described, allows the computer system to be built, initialized, and tested before the biometric security system is enabled. That is, the hardware manufacturer may build the system, install the BIOS, run test software on the system, install the OS, and install other system software elements before enabling the biometric security system.

It should be noted that the write-once memory described above is somewhat special. Initially such a memory would start out in an inactive state (i.e., the biometric security system is not enabled). This memory may then be switched to the active state, but is preferably not configured to be switched back. In one embodiment, this memory may be a BIOS-provided protected storage service. In this case, the BIOS would provide a specifically protected area of storage space that would emulate the function of a one-time, settable control, as will be appreciated by those of skill in the art. This storage space would be protected even if the BIOS is reloaded or written over. The Phoenix Corporation has discussed producing this kind of BIOS structure, although it is presently not available to applicant's knowledge.

In commercial use, a computer manufacturer may enable the biometric security system before the computer leaves the factory and provide the user with a specific password to gain initial access to the computer. Alternatively, the manufacturer could leave the biometric security system disabled when the computer is shipped. In this case, the biometric security system would not be enabled until the user himself indicates that he wishes it to be activated. The OS instructions 24 would then cause the processor 17 to activate the enabling circuit 21 responsive to this command from the user (see FIG. 3). Once activated, the biometric security system takes over and is preferably configured so that it may not be disabled thereafter.

The above approach of using an enabling circuit 21 to provide a biometric security system that can be left inactive during initial building and testing of the computer 10 and then activated later is a very strong theft deterrent. That is, the biometric security system is enabled by a physical change in the enable device. Thus, a would-be thief cannot “hack” into the OS software to restore the computer 10 to its initial configuration (i.e., where the biometric security system is disabled). This makes rendering a stolen computer ready for use by others substantially impossible without physically altering the hardware of the computer 10. It is anticipated that the decreased likelihood of being able to use a stolen computer with the biometric security system of the present invention will prevent many thieves from taking the risks associated with stealing the computer.

Other examples of enabling devices 21 include jumpers on the motherboard 22 (or separate circuit card where the biometric security system is incorporated on the separate card, as described above) that disable the biometric security system. Similarly, cuttable traces that can be cut when the biometric security system is to be enabled may also be used, as will be understood by those of skill in the art. Of course, some of these devices may be used as back doors by knowledgeable thieves to defeat the biometric security system (e.g., jumpers) after it has been installed and activated. Using an integrated write-once memory as described above is likely to be the most difficult of the enabling devices for thieves to circumvent. Of course, the particular enabling device 21 used will depend upon design preference and the amount of security that is desired, as well as other design constraints which will be appreciated by those of skill in the art.

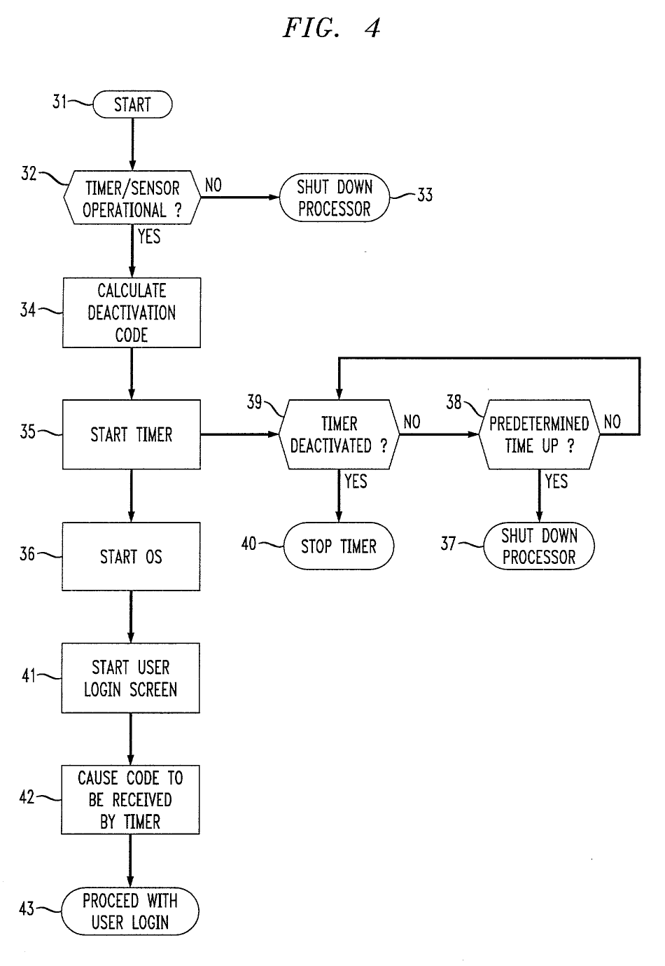

Turning now additionally to FIG. 4, normal operation of the biometric security system according to the invention will be further described. The following description assumes that if the enabling device 21 discussed above is present, that it has already been activated and the biometric security system is therefore enabled. Normal operation begins (Block 31) when power to the computer 10 is initially turned on. The processor 17 powers up and starts running the BIOS instructions 23. The BIOS instructions 23 cause the processor 17 to verify that the biometric security sensor 14 and/or the timer 19 are installed and operational, at Block 32.

If the timer 19 and/or biometric security sensor 14 are not installed and operational, the BIOS instructions cause the processor 17 to shut down (Block 33). A control circuit or processor 25 may be included for interfacing with the timer 19 to verify installation and operation thereof. For example, the control circuit 25 may be desirable if the biometric security system hardware is incorporated on a separate circuit board and not on the motherboard 22, as described above.

If the timer 19 and/or biometric security sensor 14 are operational, the BIOS instructions 23 cause the processor 17 to calculate the deactivation code at Block 34. The deactivation code may be loaded into a storage device 26, such as a register, for example. The BIOS instructions also cause the processor 17 to preset (i.e., reset) and start a counter/timer 45 (Block 35), prior to the processor operating based upon the OS instructions 24 (Block 36). The counter/timer 45 shuts down the processor 17 (Block 37) a predetermined time after being started (Block 38) unless the deactivation code is received (Block 39), in which case the counter/timer is stopped (Block 40) and the processor will not be shut down.

As shown at Block 41, the OS instructions 24 cause the processor 17 to proceed through to its user login screen. The login screen preferably does not have a cancel option or allow for a ctrl-alt-delete or other interrupt to bypass the login. The login requires the user to identify himself using at least one biometric before proceeding. Of course, those of skill in the art will appreciate that other identifying indicia, such as an alphanumeric password, for example, may also be used in accordance with the present invention. The OS instructions 24 cause the processor 17 to cooperate with the biometric security sensor 14 for causing the deactivation code to be received by the timer 19 based upon the at least one sensed user biometric indicating an authorized user.

For example, a storage device 30 (e.g., a register) may receive and store this deactivation code for comparison with the deactivation code stored in the storage device 26. This comparison determines whether the correct biometric was received and, if so, a stop signal is provided to the counter/timer 45 so that it does not shut down the processor 17. The comparison may be performed by a comparator 29, for example, although other suitable devices known to those of skill in the art will also suffice.

A switch 27 may be included in the timer 19 for shutting down the processor 17. For example, the switch may include a NOR logic gate 28 receiving as inputs a timeout signal from the counter/timer 45 indicating that the predetermined time has passed and a signal from the comparator 29 indicating whether the correct biometric was received. An output from the NOR logic gate 28 may be coupled to an input of an AND logic gate 31, an output of which provides a shut down signal to the processor 17. Another input of the AND logic gate 31 may receive a signal indicating that the timer 19 or biometric security sensor 14 is not installed and operational so that the processor 17 will be shut down, as discussed above.

Again, the biometric may be the user's fingerprint, or a password or other suitable identification may be used, as will be appreciated by those of skill in the art. Once the biometric has been received and the timer deactivated, operation of the biometric security system is complete at Block 43.

It should be noted that one of the implications of placing the biometric security system in both the BIOS and the operating system is that running the machine without its operating system is essentially not practical. This results in additional configuration considerations if the user operates the Windows® operating system, for example. That is, many computers running Windows® currently have an option to boot directly to the Microsoft® disk operating system (MS-DOS), for example, that never activates the Windows® operating system. In this scenario, since Windows® has never been activated and the biometric security system is never executed, the processor 17 will be shut down without providing the user an opportunity to enter the biometric. To address this special situation, the boot to MS-DOS mode may be eliminated so that the user may execute MS-DOS only through Windows® (i.e., as an MS-DOS “shell”). Another option is to make special provisions so that the biometric security system operates in MS-DOS mode as well, as will be appreciated by those of skill in the art.

Having read the above description, those of skill in the art will appreciate the numerous advantages of the present invention. For example, the present invention prevents a computer's hardware from functioning independent from its operating system without requiring the user to login twice. As noted above, when BIOS resident authentication systems are used, the user must log in once for the BIOS authentication and a second time for the operating system. By protecting the hardware using OS resident user authentication, the double login is eliminated.

Furthermore, the present invention allows for multiple forms of biometric authentication to be used. Again, when a user authentication system is installed in the BIOS it is the only authentication system that can be used without changing the BIOS. The biometric security system of the present invention allows hardware protection using any authentication system installed in the operating system login (including multiple biometrics, simultaneously or separately).

Additionally, a user of the present invention has the flexibility to update and to install alternative authentication hardware. When a BIOS resident authentication system is installed on a computer, it generally must be installed at the factory, and cannot be easily changed or upgraded by the user. Moreover, larger and more “user-friendly” authentication software may be used in accordance with the present invention. As noted above, BIOS resident authentication software has very limited functionality because it must be small enough to fit into the limited storage space available to the BIOS. OS resident authentication software does not have this limitation and can perform stronger biometrics and display “friendlier” GUIs.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. A computer comprising:
at least one memory;
basic input/output system (BIOS) instructions and operating system (OS) instructions stored in said at least one memory;
a processor connected to said at least one memory and which upon starting first operates based upon said BIOS instructions and thereafter operates based upon said OS instructions;
a timer for shutting down said processor a predetermined time after being started unless a deactivation code is received;
said BIOS instructions causing said processor to calculate the deactivation code and start said timer; and
a biometric security sensor cooperating with said processor for causing the deactivation code to be received by said timer based upon at least one sensed user biometric indicating an authorized user.

2. The computer of claim 1 further comprising an enabling device which until activation prevents said timer from shutting down said processor.

3. The computer of claim 2 wherein said enabling device comprises at least one of a write-once memory, a jumper, and a fusible link.

4. The computer of claim 2 wherein said OS instructions cause said processor to activate said enabling circuit responsive to a command from a user.

5. The computer of claim 1 wherein said BIOS instructions cause said processor to calculate the deactivation code and start said timer prior to said processor operating based upon said OS instructions.

6. The computer of claim 1 wherein said OS instructions cause said processor to cooperate with said biometric security sensor for causing the deactivation code to be received by said timer.

7. The computer of claim 1 wherein said BIOS instructions cause said processor to check and verify that said biometric security sensor is installed and operational.

8. The computer of claim 1 wherein said BIOS instructions cause said processor to check and verify that said timer is installed and operational.

9. The computer of claim 1 wherein said biometric security sensor comprises a fingerprint sensor.

10. The computer of claim 1 wherein said at least one memory comprises a ROM memory for storing said BIOS instructions and a magnetic disk for storing said OS instructions.

11. A computer comprising:
a read only memory (ROM) having basic input/output system (BIOS) instructions stored therein;
a magnetic disk having operating system (OS) instructions stored therein;
a processor connected to said ROM and magnetic disk and which upon starting first operates based upon said BIOS instructions and thereafter operates based upon said OS instructions;
a timer for shutting down said processor a predetermined time after being started unless a deactivation code is received;
said BIOS instructions causing said processor to calculate the deactivation code and start said timer;
a biometric security sensor cooperating with said processor for causing the deactivation code to be received by said timer based upon at least one sensed user biometric indicating an authorized user; and
an enabling device which until activation prevents said timer from shutting down said processor.

12. The computer of claim 11 wherein said enabling device comprises at least one of a write-once memory, a jumper, and a fusible link.

13. The computer of claim 11 wherein said OS instructions cause said processor to activate said enabling circuit responsive to a command from a user.

14. The computer of claim 11 wherein said BIOS instructions cause said processor to calculate the deactivation code and start said timer prior to said processor operating based upon said OS instructions.

15. The computer of claim 11 wherein said OS instructions cause said processor to cooperate with said biometric security sensor for causing the deactivation code to be received by said timer.

16. The computer of claim 11 wherein said BIOS instructions cause said processor to check and verify that said biometric security sensor is installed and operational.

17. The computer of claim 11 wherein said BIOS instructions cause said processor to check and verify that said timer is installed and operational.

18. The computer of claim 11 wherein said biometric security sensor comprises a fingerprint sensor.

19. A biometric security system for a computer comprising at least one memory having basic input/output system (BIOS) instructions and operating system (OS) instructions stored therein and a processor connected to said at least one memory and which upon starting first operates based upon said BIOS instructions and thereafter operates based upon said OS instructions, the biometric security system comprising:
a timer for shutting down the processor a predetermined time after being started unless a deactivation code is received;
BIOS instructions for causing the processor to calculate the deactivation code and start said timer; and
a biometric security sensor for cooperating with the processor for causing the deactivation code to be received by said timer based upon at least one sensed user biometric indicating an authorized user.

20. The biometric security system of claim 19 further comprising an enabling device which until activation prevents said timer from shutting down the processor.

21. The biometric security system of claim 20 wherein said enabling device comprises at least one of a write-once memory, a jumper, and a fusible link.

22. The biometric security system of claim 20 wherein the OS instructions cause the processor to activate said enabling circuit responsive to a command from a user.

23. The biometric security system of claim 19 wherein said BIOS instructions cause the processor to calculate the deactivation code and start said timer prior to the processor operating based upon said OS instructions.

24. The biometric security system of claim 19 wherein the OS instructions cause the processor to cooperate with said biometric security sensor for causing the deactivation code to be received by said timer.

25. The biometric security system of claim 19 wherein said BIOS instructions cause the processor to check and verify that said biometric security sensor is installed and operational.

26. The biometric security system of claim 19 wherein said BIOS instructions cause the processor to check and verify that said timer is installed and operational.

27. The biometric security system of claim 19 wherein said biometric security sensor comprises a fingerprint sensor.

28. A method for reducing unauthorized access to a computer comprising a processor, the method comprising:
calculating a deactivation code and starting a timer responsive to basic input/output system (BIOS) instructions;
causing the deactivation code to be received by the timer based upon at least one sensed user biometric indicating an authorized user; and
shutting down the processor a predetermined time after being started unless the deactivation code is received by the timer.

29. The method claim 28 wherein the BIOS instructions cause the processor to calculate the deactivation code and start the timer prior to operating the processor based upon operating system (OS) instructions.

30. The method of claim 28 further comprising checking and verifying that the timer is installed and operational responsive to the BIOS instructions.

31. The method of claim 28 wherein the at least one sensed user biometric comprises fingerprint data.
